(19) United States
(12) Patent Application Publication
(10) Pub. No.: US 2006/0144778 A1
(43) Pub. Date: Jul. 6, 2006

(54) Low stress, ultra-thin, uniform membrane, methods of fabricating same and incorporation into detection devices

(76) Inventors: Frank J. Grunthaner, Glendale, CA (US); Victor E. White, Altadena, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/192,553

(22) Filed: Jul. 29, 2005

Related U.S. Application Data
(60) Provisional application No. 60/593,028, filed on Jul. 29, 2004.

(51) Int. Cl. C23F 1/00; C02F 1/44

(52) U.S. Cl. 210/321.84; 216/56; 216/2; 438/22; 257/619; 438/977

(57) ABSTRACT

The present disclosure is directed, in part, to a method for fabricating a low-stress, ultra-thin membrane as well as the low-stress, ultra-thin membrane formed by this method. The method includes: layering a first layer on a semiconductor substrate; etching a hole in the first layer; layering a second layer on the membrane of the first layer and over the hole; and etching the substrate beginning from the bottom surface thereof, such that at least a portion of the substrate aligned with the hole in the first layer is removed. The first and second layers are made of substantially the same material, which will usually be silicon nitride, however, it is contemplated that other dielectric materials could be used, but it is preferred that the second layer has an amorphous structure. It is preferred that the second layer be formed with a slightly bubble-shape to help deflect stresses on the second layer. Generally, low pressure chemical vapor deposition will be used to create at least the first and second layers. As a result of this basic method, the second layer has an ultra-thin thickness. Among other devices, the ultra-thin membrane is useful in a device for detecting physical characteristics of a sample bombarded with electrons. In such a device, the ultra-thin, low-stress membrane is positioned adjacent a electron detector. The device may further include an evacuated chamber at least partially bounded by the ultra-thin low-stress membrane.

### CROSS-REFERENCE TO RELATED APPLICATIONS

This patent claims the benefit of U.S. Provisional Application No. 60/593,028, filed Jul. 29, 2004.

### GOVERNMENT FUNDING STATEMENT

The invention described herein was made in the performance of work under a NASA contract, and is subject to the provisions of Public Law 96-517 (35 USC §202) in which the Contractor has elected to retain title.

### BACKGROUND OF THE INVENTION

1. Field of the Invention

The present invention generally relates to a semiconductor structure and its fabrication, and more particularly, a low stress, ultra-thin membrane.

2. Background Information

The use of electron-transparent membranes to serve as enclosures for evacuated equipment and/or specimen chambers is known. The ability of electrons to penetrate a certain thickness of a solid is measured by its “electron range.” T. E. Everhart and P. H. Hoff, “Determination of Kilovolt Electron Energy Dissipation vs Penetration Distance in Solid Materials,” J. Appl. Phys. 42, 5837 (1971). Electrons with energies in the kilo-electron volt range, traveling in a solid, are scattered inelastically in collisions with the electrons in the material. For low-Z materials, such as organic insulators, scattering from the valence electrons is the major loss mechanism for incident electron energies from 10 eV to 10 keV.

Maximum thicknesses for electron transparency are also known. Still, the practical problem of actually fabricating a viable membrane that was thinner than the maximum thickness remained. Currently known fabrication techniques and materials cannot provide sufficiently thin membranes for use with low energy electrons and similar particles, such as photons. These types of low energy particles are associated with low energy X-ray, soft X-ray, X-ray microscopes, Extreme Ultra Violet, and Vacuum Ultra Violet analyses. Consequently, there is a need in the art for ultra-thin membranes that will provide transparency to low energy electrons. There is an associated need for such a viable membrane that could be made using Chemical Vapor Deposition (CVD), which it would make such membranes easier to manufacture.

### SUMMARY OF THE INVENTION

The present disclosure is directed, in part, to a method for fabricating a low-stress, ultra-thin membrane as well as the low-stress, ultra-thin membrane, itself. The method includes: layering a first layer on a semiconductor substrate; etching a hole in the first layer; layering a second layer on the membrane of the first layer and over the hole; and the substrate beginning from the bottom surface thereof, such that at least a portion of the substrate aligned with the hole in the first layer is removed. These holes are preferrably created by etching, which may take the form of reactive ion etching, plasma etching, wet etching, and various combinations thereof. The first and second layers are made of substantially the same material, which will usually be silicon nitride, however, it is contemplated that other dielectric materials could be used. Generally, low pressure chemical vapor deposition will be used to create at least the first and second layers. As a result of this basic method, the second layer has an ultra-thin thickness.

In a preferred approach, the second layer has an amorphous structure. With such a structure, the method can further include measuring the thickness of the second layer (or membrane) and thinning the membrane to a desired thickness. The amorphous structure minimizes concern that such thinning could create undesirable pinholes in the second layer.

It is preferred that the second layer be formed with a slightly bubble-shape (i.e. semi-spherical like an egg shell) to help deflect stresses on the second layer. It may also be preferable to remove the substrate from the first layer near the end of fabrication.

The present disclosure also teaches, in part, a semiconductor structure having an, ultra-thin low-stress membrane including a first layer having a hole etched therein; and a second layer layered on the first layer, the first layer and second layer being comprised of substantially the same material, which will usually be silicon nitride, however, it is contemplated that other dielectric materials could be used. Generally, low pressure chemical vapor deposition will be used to create at least the first and second layers. The second layer has an ultra-thin thickness. The second layer may also have an amorphous structure and have a slightly bubble-shape to help deflect stresses on the second layer.

The semiconductor is useful in, among other devices, a device for detecting physical characteristics of a sample bombarded with low-energy electrons. In such a device, the ultra-thin, low-stress membrane of the novel semiconductor structure is positioned adjacent a detector. The device may further include an evacuated chamber at least partially bounded by the ultra-thin low-stress membrane.

### BRIEF DESCRIPTION OF THE DRAWINGS

FIG. 1 is a cross-sectional view of a low stress, ultra-thin, uniform membrane showing a physical structure of the present invention.

FIG. 1A is a cutaway top plan view of the first layer depicting the array of tiny (micron scale) holes formed through the nitride to the silicon wafer.

FIGS. 2A-2G are cross-sectional views illustrating the various steps performed in fabricating a low stress, ultra-thin, uniform membrane according to the present invention.

FIGS. 3A and 3B are schematic illustrations of devices for detecting physical characteristics of sample using a low stress, ultra-thin, uniform membrane and a detector.

FIGS. 4A, 4B and 4C are SEM analyses of an ultra-thin membrane at various voltages.

### DETAILED DESCRIPTION

While the present invention may be embodied in many different forms, the drawings and discussion are presented with the understanding that the present disclosure is an exemplification of the principles of the invention and is not intended to limit the invention to the embodiments illustrated.

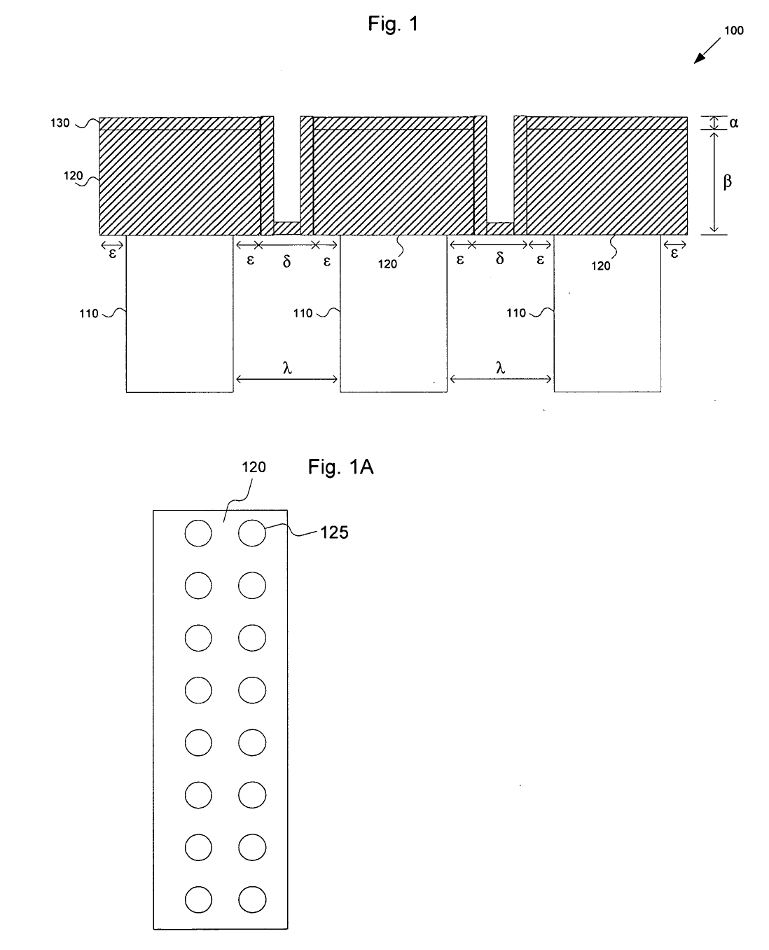

FIG. 1 is a cross-sectional view of a low stress, ultra-thin membrane 100. As shown in FIGS. 1 and 1A, the membrane 100 includes a first layer 120 having one or more holes of width δ, etched therein. Membrane 100 further includes a second layer 130. The first layer 120 and second layer 130 are comprised of substantially the same material. It is preferred that the first and second layers, be comprised essentially of silicon nitride. However, it is contemplated that other dielectric materials could be used instead of silicon nitride for the first and second layers, especially those that are amorphous such as silicon oxide, silicon carbide, and Halfnium nitride, to name a few. Amorphous films are preferred because during the growth process amorphous films don't nucleate, but they do result in a material layer having a tight network of bonds with a very uniform thickness. These characteristics of amorphous films permit the second layer 130 to be thinned down in a controlled manner to virtually any thickness, even thicknesses in the sub-50 Å range, while remaining virtually pin-hole free.

It is crucial to the present invention for the second layer 130 to have a uniform, ultra-thin thickness. In the context of the present application, ultra-thin means a thickness, α, of the selected material that is transparent to low energy (1 KeV) electrons. For silicon nitride at these energies, ultra-thin means, α, of no greater than approximately 40-50 Å. Using known equations, the thickness necessary for transparencies to various electron energies for various compounds can be readily determined.

It is also important that membrane be low-stress to minimize the potential for self-destruction. One of the main reasons the final membrane is surprisingly robust is the fact that it is composed of a thick layer and a thin layer composed of the same materials with largely the same physical properties. Another significant reasons the membranes is surprisingly strong is the fact that by the nature of the process disclosed herein, the little membranes are slightly bubbled in shape, so they are semi-spherical like an egg shell, which is a mechanically-strong shape. With this bubble shape it will be compliant and able to take up stresses that are applied to it. In addition, silicon nitride has also proven to be a wonderfully strong material.

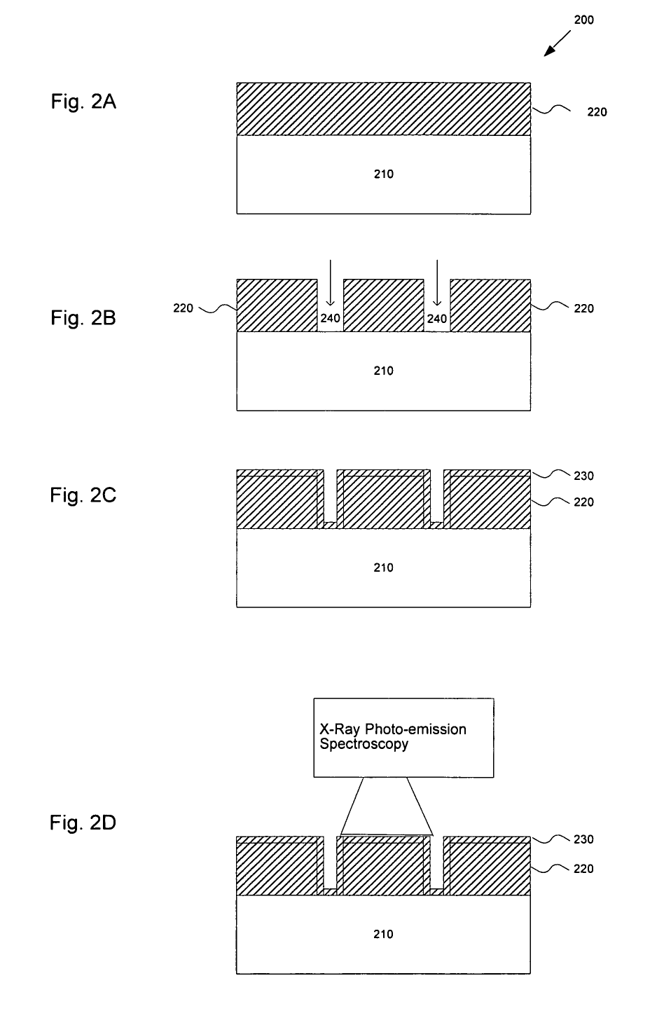

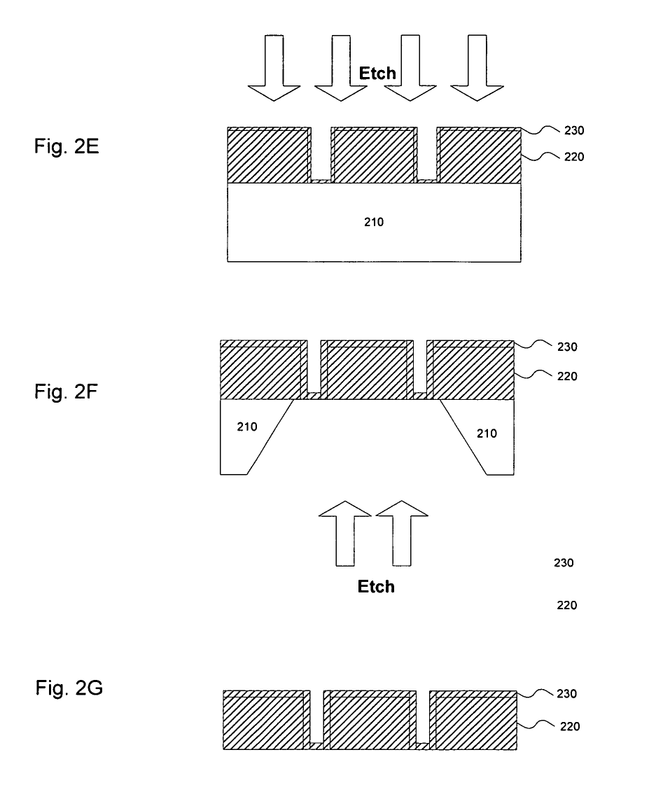

In the preferred approach these results are achieved through a “re-growth” technique, which can be illustrated referring to a silicon nitride embodiment, as follows:
1. a first layer of silicon nitride 220 is formed on silicon substrate or wafer 210 (FIG. 2A)
2. an array of tiny (micron scale) holes 240 are made in the thicker first silicon nitride layer 220 by etching through the nitride to the silicon wafer 210 (FIG. 2B). In particular, the array is formed by covering the entire surface of the first layer with “photoresist” and then, using a glass plate with an opaque pattern on it, the wafer is exposed to UV light. As a result, the are where the UV hits the photoresist can be washed away with a developer. The first layer is then preferably etched in a Reactive Ion Etcher (RIE)(using a mixture of CF4 and O2), which is timed so that it etches just barely through the first layer that is exposed to the plasma. Everywhere else, the photoresist protects the first layer. After the RIE, the photoresist is cleaned off with a solvent (e.g. acetone) and is ready for the next step.
3. Then a very thin coating (or second layer) of silicon nitride 230 is grown over the entire wafer again on top of the first silicon nitride layer 220 (FIG. 2C). The portions of the second layer of silicon nitride 230 formed in the holes 240 (i.e. the portions comprising the ultra-thin membrane) are also be slightly bubbled in shape. This is due to a non-uniform etch rate in the first layer of silicon nitride 220 during step 2. More specifically, the etching of the first layer of silicon nitride 220 is slightly stronger in the middle of the formed holes 240 than at the perimeter of the formed holes 240. As a result, the second layer of “re-grown” silicon nitride becomes slightly bubble shaped.
4. In some circumstances, X-ray Photo-emission Spectroscopy (XPS) is used to accurately determine the average thickness of second layer 230 (down to the Angstrom level) (FIG. 2D). Of course, other techniques for measuring the thickness of a layer may also be used.
5. Where the thickness of second layer 230 is greater than desired, the second layer 230 can be thinned down in a controlled manner **(FIG. 2E).
6. After the desired thickness of second layer 230 is achieved, an opening is made on the backside of the silicon wafer and a very selective etch eats the silicon substrate 110 away (FIG. 2F), leaving a free standing membrane of the thick nitride with the array or little openings within the second, thin nitride layer (FIG. 2G).

The deposition process used in the preferred approach is LPCVD (Low Pressure Chemical Vapor Deposition). The LPCVD material is much stronger and more uniform than other silicon nitride processes. For example, silicon nitride made via evaporation or PECVD (Plasma Enhanced Chemical Vapor Deposition) does not make membrane quality material. LPCVD also allows for a the material to be deposited evenly, as opposed to evaporation which deposits the material in a line-of-sight from the source. Also, there's the contribution of the silicon nitride itself. Silicon nitride a super hard, super strong material with a hardness on the order of 9 on the mohs scale. Of course, it should be understand by those of ordinary skill in the art having the present specification before them that the present technique will also work with other materials, such as those listed above.

The method also presents a relatively simple way to make many of these membranes in a tightly packed formation.

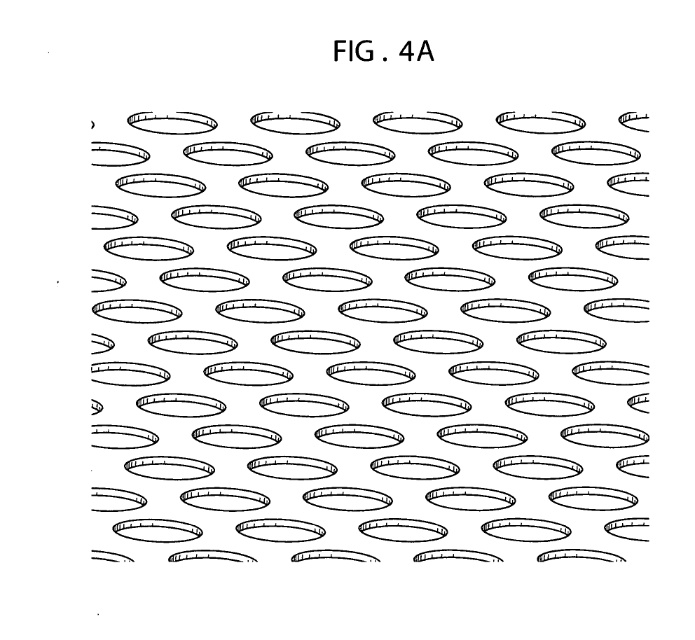

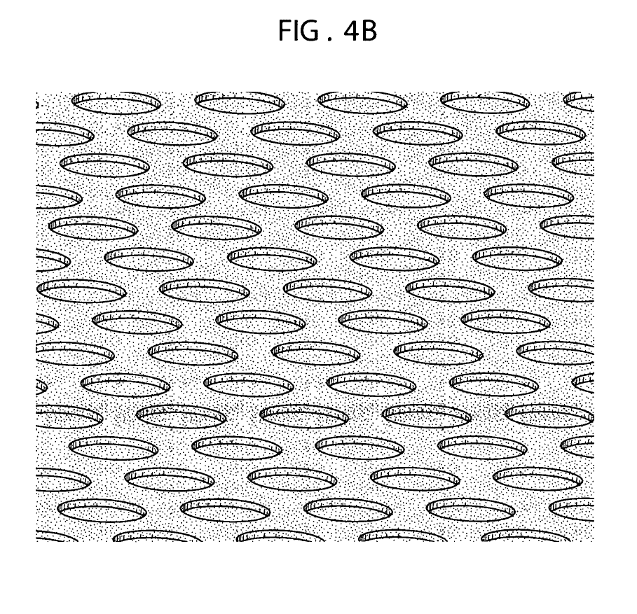

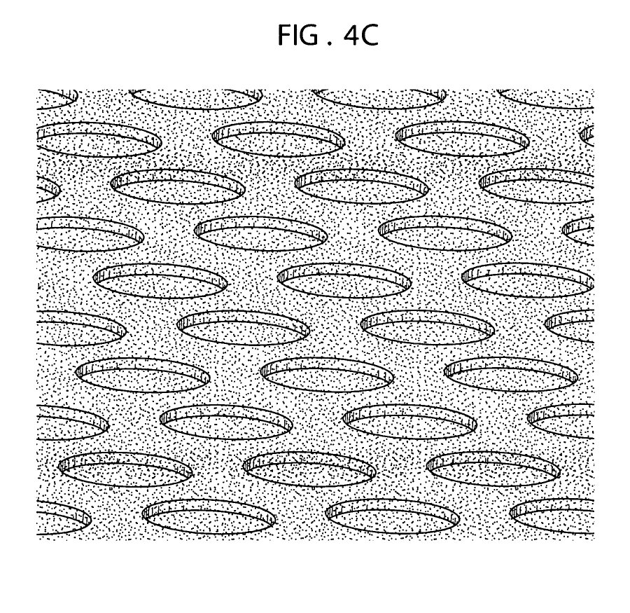

FIGS. 4A, 4B and 4C show SEMs (scanning electron microscope) analyses using different electron energies of a membrane (α of second layer is approximately 40-50 Å) made according to the present disclosure. In particular, FIG. 4A was imaged at 2500 Volts, FIG. 4B was imaged at 1000 Volts, and FIG. 4C was imaged at 750 V. These images demonstrate that for higher electron voltages (energy) these membranes are transparent. In particular, at 2500 V (FIG. 4A) the little ellipses are perfectly black, indicating that the electrons go straight through the holes in the first layer (120, 220). At 1000 V (FIG. 4B), they start to become visible, meaning a few of the electrons are scattered, and at 750 V (FIG. 4C) even more of the electrons interact with the membranes.

Membrane 100 can also be used higher energy electrons where particularly higher strength windows are desired. The present method makes a stronger silicon nitride window than could be made with a single thickness nitride process. So, for instance, electron energies of something like 20000 Volt electrons will be transparent where a of second layer is approximately 2000 Angstroms thick.

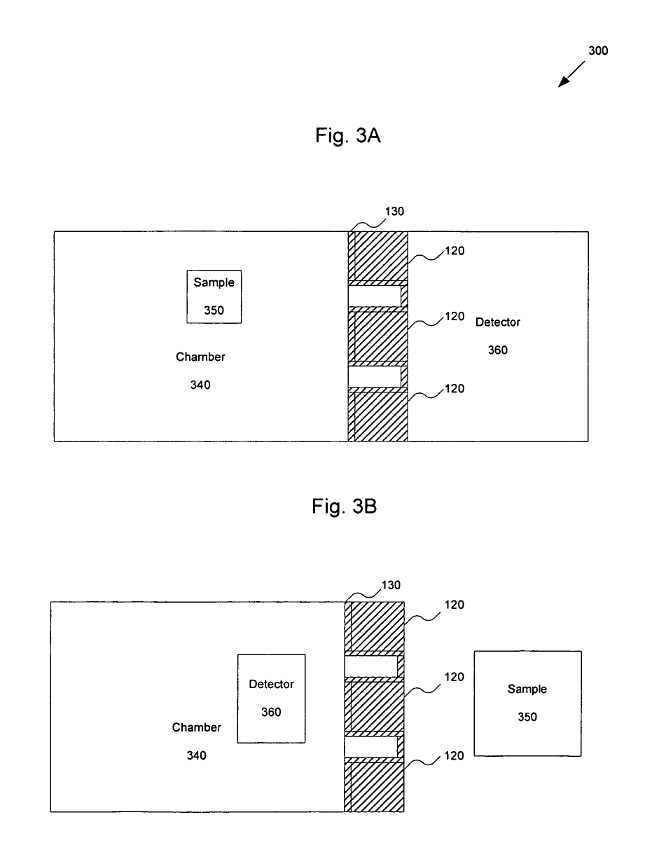

The membrane is useful in devices for detecting physical characteristics of a sample bombarded with low-energy electrons. In such a device, the ultra-thin, low-stress membrane is positioned adjacent a detector. The device may further include an evacuated chamber at least partially bounded by the ultra-thin low-stress membrane. FIG. 3A is a schematic view of such a device. The dectector may detect low-energy electrons, low energy X-rays, or VUV (for Vacuum Ultra Violet), soft X-rays (or EUV, for Extreme Ultra Violet light) or even photons.

The detector can be used to separate an ultrahigh vacuum from a much rougher and cruder vacuum or for running experiments in water using tools that are not compatable with water (e.g. looking at a live cell with an electron or an X-ray microscope). As shown in FIG. 3B, it is also possible that the detector, itself, rather than the sample could be in the evacuated chamber bounded at least in part by the novel membrane disclosed herein.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing for its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A method for fabricating a low-stress, ultra-thin membrane over a substrate, the substrate having a top surface and a bottom surface, the method comprising:
layering a first layer on the substrate;
etching a hole in the first layer;
layering a second layer on the first layer and over the hole, the first layer and second layers being comprised of substantially the same material with the second layer having an ultra-thin thickness; and
etching the substrate beginning from the bottom surface thereof, such that at least a portion of the substrate aligned with the hole in the first layer is removed.

2. The method according to claim 1 wherein the second layer has an amorphous structure, the method further comprising:
measuring the thickness of the second layer; and
thinning the second layer to a desired thickness.

3. The method according to claim 2 wherein the second layer is formed with a slightly bubble-shape to help deflect stresses on the second layer.

4. The method according to claim 1 wherein the second layer is formed with a slightly bubble-shaped to help deflect stresses on the second layer.

5. The method of claim 1, wherein the substrate is composed of silicon, the first layer is composed of silicon nitride, and the second ultra-thin layer is composed of silicon nitride.

6. The method of claim 1, wherein the layering of the first layer and second layer is performed using low pressure chemical vapor deposition.

7. The method of claim 1, wherein the etching of the hole in the first layer and the hole through the substrate is selected from the group comprising reactive ion etching, plasma etching, wet etching, and combinations thereof.

8. A low-stress, ultra-thin membrane, being fabricated by the method comprising:
layering a first layer on a substrate, the first layer providing a membrane;
etching a hole in the first layer;
layering a second layer on the membrane and over the hole, the first layer and second layer being comprised of the same material; and
etching the substrate beginning from the bottom surface thereof, such that at least a portion of the substrate aligned with the hole in the first layer is removed.

9. The low-stress, ultra-thin membrane according to claim 8 wherein the second layer has an amorphous structure and the method of fabricating same further comprising:
measuring the thickness of the second layer; and
thinning the second layer to a desired thickness.

10. The low-stress, ultra-thin membrane according to claim 9 wherein the second layer has a slightly bubble-shape to help deflect stresses on the second layer.

11. The low-stress, ultra-thin membrane according to claim 8 wherein the second layer has a slightly bubble-shape to help deflect stresses on the second layer.

12. The low-stress, ultra-thin membrane of claim 8, wherein the substrate is composed of silicon, the first layer is composed of silicon nitride, and the second layer is composed of silicon nitride.

13. The low-stress, ultra-thin membrane of claim 8, wherein the layering of the first layer and second layer is performed using low pressure chemical vapor deposition.

14. The low-stress, ultra-thin membrane of claim 8, wherein the method further comprises removing the substrate after fabrication of the membrane.

15. A semiconductor having an, ultra-thin low-stress membrane comprising:
a first layer having a hole etched therein; and
a second layer layered on the first layer, the first layer and second layer being comprised of substantially the same material and the second layer being ultra-thin.

16. The invention according to claim 15 wherein the second layer has an amorphous structure.

17. The invention according to claim 16 wherein the second layer has a slightly bubble-shape to help deflect stresses on the second layer.

18. The invention according to claim 15 wherein the second layer has a slightly bubble-shape to help deflect stresses on the second layer.

19. A device for detecting physical characteristics of a sample bombarded with electrons comprising:
an ultra-thin low-stress membrane including:
a first layer having a hole etched therein; and
a second layer layered on the first layer, the first layer and second layer being comprised of substantially the same material and the second layer being ultra-thin; and
a detector operably positioned adjacent the ultra-thin, low-stress membrane.

20. The invention according to claim 19 wherein the second layer has an amorphous structure.

21. The invention according to claim 20 wherein the second layer has a slightly bubble-shape to help deflect stresses on the second layer.

22. The invention according to claim 19 wherein the second layer has a slightly bubble-shape to help deflect stresses on the second layer.

23. The device of claim 19, further comprising a chamber, the chamber being at least partially bounded by the ultra-thin low-stress membrane, wherein the chamber is pressurized to create a vacuum.
